(19) United States
(12) Patent Application Publication
(10) Pub. No.: US 2012/0207466 A1
(43) Pub. Date: Aug. 16, 2012

(54) COMPACT, LIGHTWEIGHT, ENERGY EFFICIENT, LOW NOISE SHUTTER MECHANISM

(75) Inventors: Kevin L. Timpel, Woburn, MA (US); David A. Richards, Merrimack, NH (US)

(73) Assignee: BAE Systems Information and Electronic Systems Integration Inc., Nashua, NH (US)

(21) Appl. No.: 13/346,772

(22) Filed: Jan. 10, 2012

Related U.S. Application Data
(60) Provisional application No. 61/441,364, filed on Feb. 10, 2011.

(51) Int. Cl. G03B 9/08

(52) U.S. Cl. 396/463; 396/452

(57) ABSTRACT

A robust, compact, lightweight, low energy, low cost, and low noise mechanical mechanism suitable for military and other demanding applications includes a Geneva drive that transitions a camera shutter or other element between two positions and locks the shutter or other element in place between transitions, thereby isolating the remainder of the mechanism from shutter vibrations and torques. Accordingly, the mechanism controlling the Geneva drive need not be especially robust even for military applications, and can be similar in size, weight, energy consumption, and noise to a conventional shutter mechanism. The driving mechanism can include a rotary actuator or a linear actuator with a rack gear. In various embodiments the driving mechanism includes a piezomotor. In certain embodiments, the starting and ending positions of the mechanism are determined by sensors, and in some embodiments the starting and ending positions are adjustable.

### RELATED APPLICATIONS

This application claims the benefit of U.S. Provisional Application No. 61/441,364, filed Feb. 10, 2011, which is herein incorporated by reference in its entirety for all purposes.

### STATEMENT OF GOVERNMENT INTEREST

The invention was made with United States Government support under Contract No. W91CRB-07-C-0098 awarded by the US Department of the Army. The United States Government has certain rights in this invention.

### FIELD OF THE INVENTION

The invention relates to mechanical mechanisms, and more particularly, to mechanisms that toggle an element such as a camera shutter between two distinct positions.

### BACKGROUND OF THE INVENTION

A camera shutter is a mechanical device that is utilized to control the exposure of a camera's imaging system to electromagnetic radiation. In the case of an infrared camera, the shutter, when closed, can also be used as a uniform surface for calibration of the imaging system.

With reference to FIG. 1, for some applications, such as military applications, mechanical camera shutters need to be robust in order to endure the harsh environments in which they are sometimes used. In particular, these mechanical devices need to be sufficiently resilient to support the high shock loads, vibrations, and wide temperature ranges that arise in ground combat, as well as during aircraft and missile flights. As can be seen in FIG. 1, a shutter 100 in a typical high-performance application can extend away from its driving mechanism 102, so that any shock, vibration, or torque applied to the shutter 100 results in a strong torque being applied to the drive mechanism 102. Accordingly, the drive mechanism 102 in such an apparatus must be sufficiently robust to be able to withstand these applied forces.

In many combat situations, space, weight, and energy usage must all be conserved. A soldier can only carry a limited amount of weight and bulk, including batteries. In addition, a soldier can sometimes be endangered if his equipment makes audible noises. Missiles and some aircraft can also be limited in their available space, weight, and energy supply.

Nevertheless, due to the need for robustness, military grade camera shutters such as the one shown in FIG. 1 tend to occupy a considerable amount of space, with corresponding increases in size, weight, noise, and cost as compared to conventional camera shutters.

In addition, shutter mechanisms such as the one shown in FIG. 1 typically make a highly audible noise when the shutter is actuated, and they tend to draw more electrical power than conventional shutters, especially in low temperature environments if actuators 102 such as solenoids are used.

What is needed, therefore, is a mechanical device for transitioning an element such as a camera shutter between two distinct positions, wherein the device is robust in the face of harsh environmental conditions and yet the size, weight, energy consumption, cost, and noise generation of the device are all comparable to conventional, non-military camera shutters.

### SUMMARY OF THE INVENTION

A robust, compact, lightweight, low energy, low cost, and low noise mechanical mechanism includes a Geneva drive directly connected to a camera shutter or other element whereby the Geneva drive transitions the shutter between two positions. Between transitions, the Geneva drive locks the shutter in place, and thereby isolates the remainder of the mechanism from the shutter. Due to this isolation, the remainder of the mechanism need not be robust beyond requirements that would apply to a conventional shutter mechanism, thereby reducing the weight, space, noise, cost, and power requirements of the mechanism.

In embodiments, the mechanism includes a rotary actuator. In other embodiments, the mechanism includes a linear actuator and a rack gear. In various embodiments, the motor is a piezomotor. In certain embodiments, the starting and ending positions of the mechanism are determined by sensors that sense the arrival of the mechanism at the starting and ending points, and in some embodiments the starting and ending points are adjustable.

Note that, except where the context specifically requires a camera shutter, the term “shutter” is used herein to refer to any physical element that is transitioned between two mechanical positions.

The present invention is an apparatus for transitioning a switchable element between a first switched position and a second switched position. The apparatus includes an actuating mechanism that can be transitioned between a first configuration and a second configuration and a Geneva drive that includes a drive section coupled to the actuating mechanism and a shutter section coupled to the switchable element. The drive section is rotated between a first orientation and a second orientation when the actuating mechanism is transitioned between the first configuration and the second configuration, the shutter section is rotated by the drive section between a first position and a second position when the drive section rotates between the first orientation and the second orientation, and the switchable element is thereby transitioned respectively between the first switched position and the second switched position. The shutter section is unable to apply a torque to the drive section when the drive section is in either of the first orientation and the second orientation.

In various embodiments, the switchable element is a camera shutter. In some embodiments, the actuating mechanism includes a rotary actuator.

In certain embodiments the actuating mechanism includes a linear actuator. In some of these embodiments the actuating mechanism includes a pivot gear.

In some embodiments, the actuating mechanism includes a piezomotor. Various embodiments further include sensors that detect when the actuating mechanism is in one of the first configuration and the second configuration.

In certain embodiments, at least one of the first and second switched positions can be adjusted by correspondingly adjusting at least one of the first configuration of the actuating mechanism and the second configuration of the actuating mechanism. In some of these embodiments, the actuating mechanism can be mechanically adjusted. And in other of these embodiments, the actuating mechanism includes a sensor that can sense a range of configurations of the actuating mechanism, and at least one of the first and second configurations of the actuating mechanism can be electronically adjusted by adjusting a setting of a controller that receives input from the sensor.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1 is a perspective view of a robust shutter mechanism of the prior art;

FIG. 2A is a top view of an embodiment that includes a rotary actuator;

FIG. 2B is a side view of the embodiment of FIG. 1A;

FIG. 2C is a side view of an embodiment similar to FIG. 1B, but with elements of the Geneva drive inverted;

FIG. 3A is a top view of an embodiment that includes a linear actuator, shown with the shutter in a closed position;

FIG. 3B is a top view of the embodiment of FIG. 2A, shown with the shutter in an open position;

FIG. 4 is a top, enlarged view of the Geneva driver included in the embodiment of FIG. 2A;

FIG. 5A is a top view of the Geneva driver of FIG. 3, shown in starting position;

FIG. 5B is a top view of the Geneva driver of FIG. 4A, shown in a transitional position; and

FIG. 5C is a top view of the Geneva driver of FIG. 4A, shown in an ending position.

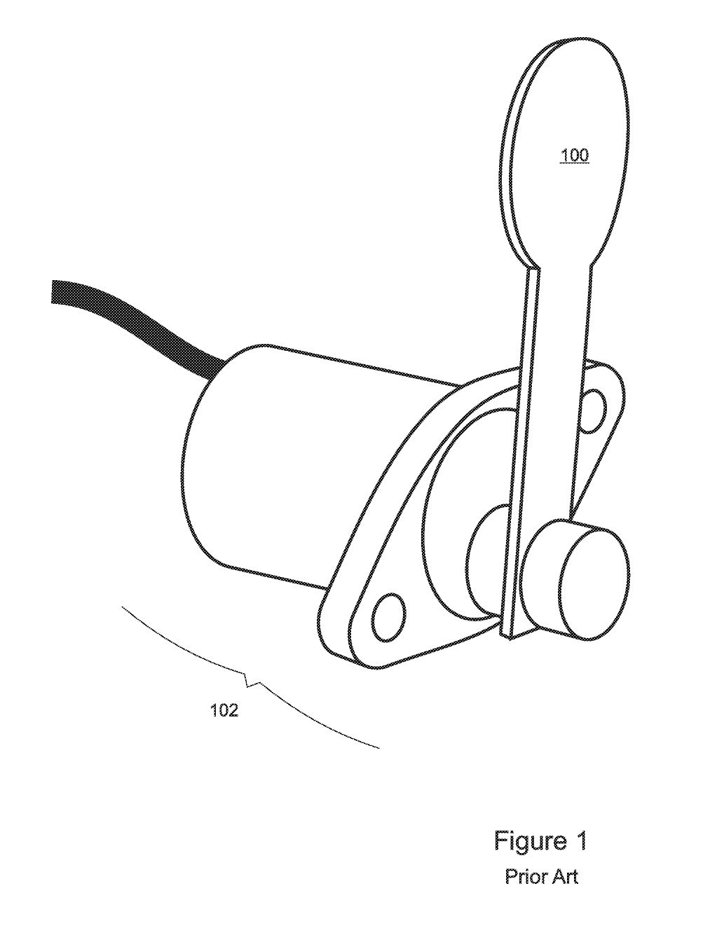

### DETAILED DESCRIPTION

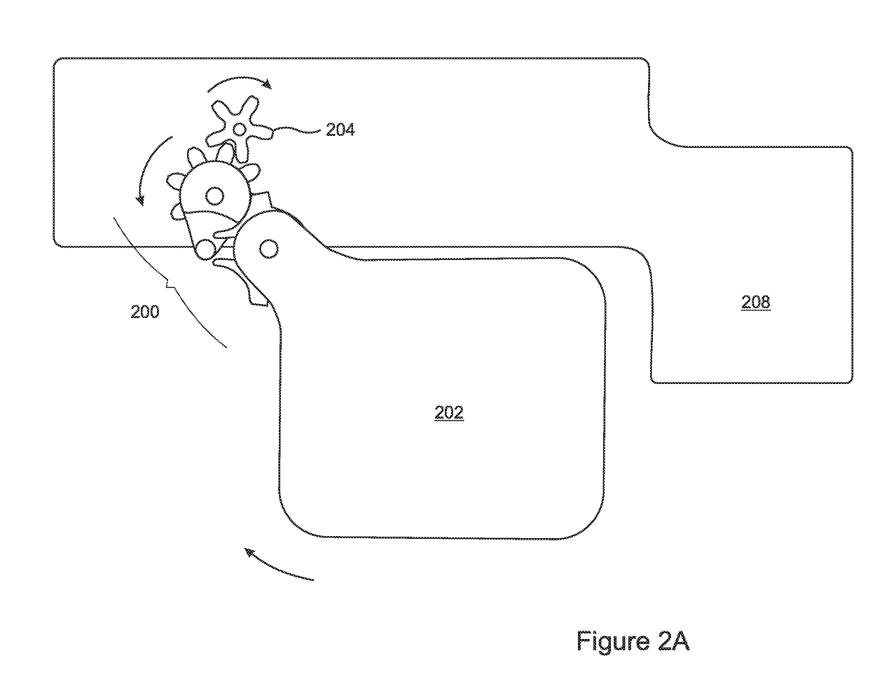

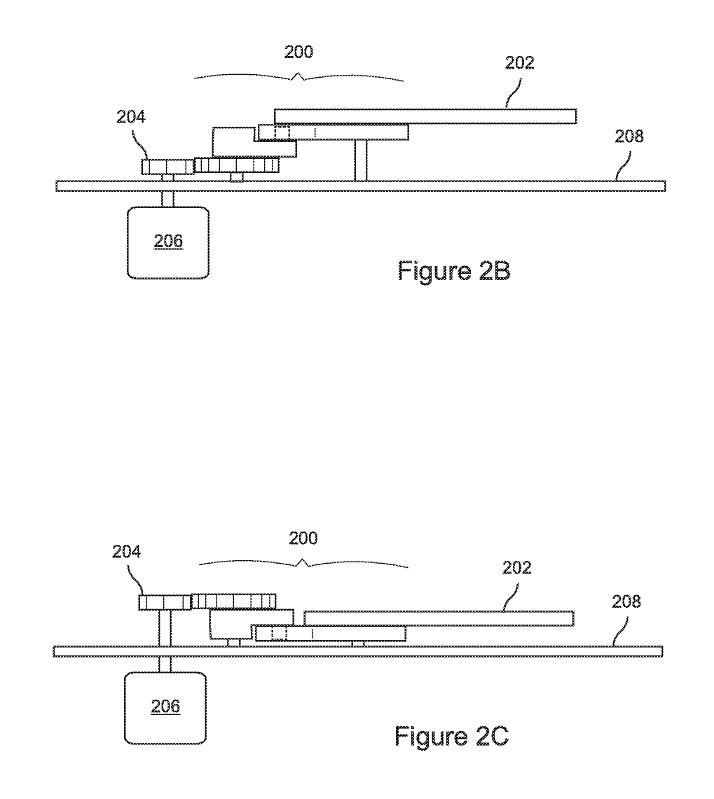

With reference to FIG. 2A, the present invention is a robust, compact, lightweight, low energy, low cost, and low noise mechanical mechanism that includes a Geneva 200 drive actuated by an actuating mechanism and directly connected to a camera shutter 202 or other element, whereby the Geneva drive 200 transitions the shutter 202 between two positions. Note that, except where the context specifically requires a camera shutter, the term “shutter” is used herein to refer to any physical element that is transitioned between two mechanical positions.

Between transitions, the Geneva drive 200 locks the shutter 202 in position, and thereby isolates the actuating mechanism from the shutter 202. Due to this isolation, the actuating mechanism need not be significantly more robust than in a conventional shutter mechanism, although in some applications it must be able to function over a wider temperature range. Isolation of the actuating mechanism by the Geneva drive thereby reducing the weight, space, noise, cost, and power requirements of the actuating mechanism.

In embodiments, the actuating mechanism includes a piezomotor. In some embodiments, the actuating mechanism includes a rotary actuator, while in other embodiments, the actuating mechanism includes a linear actuator.

FIG. 2B is a side view of the embodiment of FIG. 2A. In the embodiment of FIGS. 2A and 2B, the actuating mechanism includes a rotary actuator that comprises a drive gear 204 driven by a rotary motor 206 mounted behind a mounting plate 208. FIG. 2C is a side view of an embodiment similar to the embodiment of FIG. 2B, but with elements of the Geneva drive inverted as compared to FIG. 2B. It will be clear that other configurations are possible, and are within the scope of the invention.

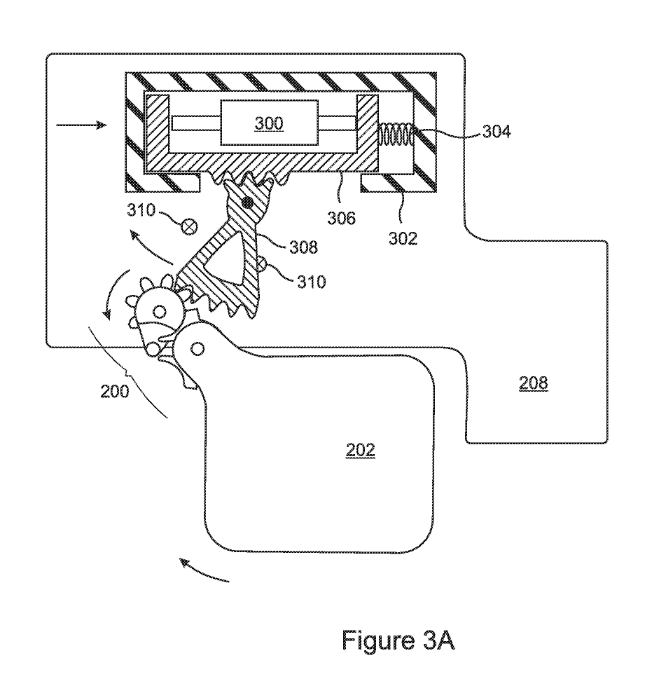

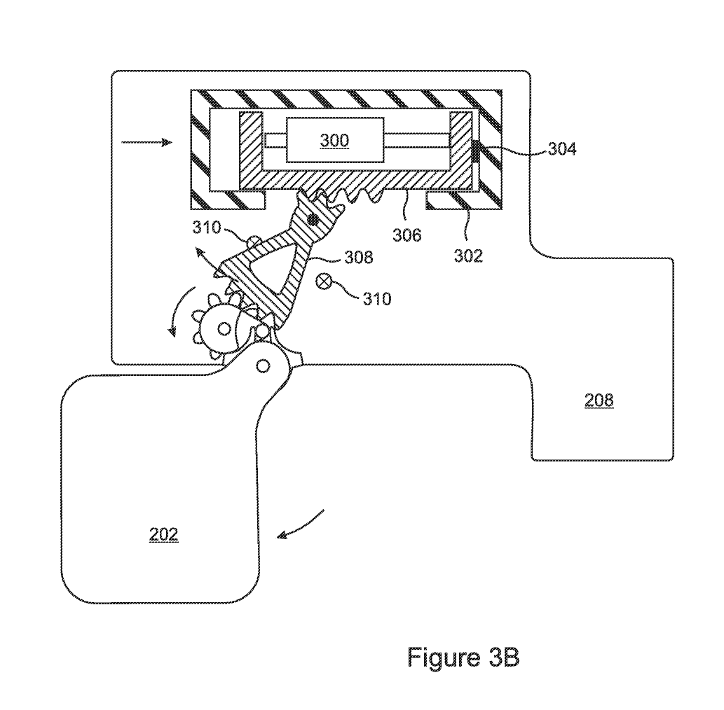

In the embodiment of FIG. 3A, the actuating mechanism includes a linear piezo-electric motor 300 surrounded by a housing 302 and coupled to a linear spring 304. The linear motor 300 drives a rack gear 306 that is coupled to a pivot gear 308 which actuated the Geneva drive 200. In the embodiment of FIG. 3A, the starting and ending positions of the pivot gear 308 are determined by sensors 310 that sense the arrival of the mechanism at the starting and ending points. The outputs of the sensors are used by a controller (not shown) to start and end the movement between positions. In some embodiments, the starting and ending points are adjustable, either mechanically or through the use of sensors that continuously sense the position of the mechanism over some range. FIG. 3A illustrates the embodiment in a “shutter-closed” configuration, while FIG. 3B shows the same embodiment in a “shutter-open” configuration.

FIG. 4 is a close-up illustration of the Geneva drive mechanism 200 of FIG. 3A and FIG. 3B. The Geneva drive 100 includes a driving section 400 and a shutter section 402, each of which is mounted by a respective pivot 404 to the mounting plate 208. The driving section 400 includes several stacked layers, while the shutter section in the embodiment of FIG. 4 includes only one plane 406. The lowest layer of the driving section is a rotary gear 408 that engages the pivot gear 308. On top of the rotary gear 408 is a base layer 410 that is able to rotate beneath the layer 406 of the shutter section 402. A drive pin 412 is mounted to the base layer 410, and extends upward to the height of the shutter section plane 406. An upper layer 414 of the driving section 400 is also located at the height of the shutter section plane 406. The upper layer 414 is mostly round, but includes an indentation 416 that is oriented toward the drive pin 412.

The shutter section plane 406 includes a notch 416 into which the drive pin 412 can enter. The notch 416 is flanked on either side by an arced portion 418 that corresponds in position and shape to the round portion of the drive section upper layer 414. FIG. 4 illustrates the Geneva drive in a starting orientation, where the drive pin 412 is not inserted into the notch 416, and where one of the arced portions 418 of the shutter section plane is closely fitted against the round section of the drive section upper layer 414. Independent movement of the shutter section 402 is impossible in this orientation, because the arced portion 418 of the shutter section plane cannot move while it is closely fitted against the round portion of the drive section upper layer 414. Furthermore, any vibration of the shutter 202 cannot be transmitted beyond the juncture between the plane 406 of the shutter portion 402 and the upper layer 414 of the drive section 400. This protects the actuating mechanism that drives the Geneva drive 200.

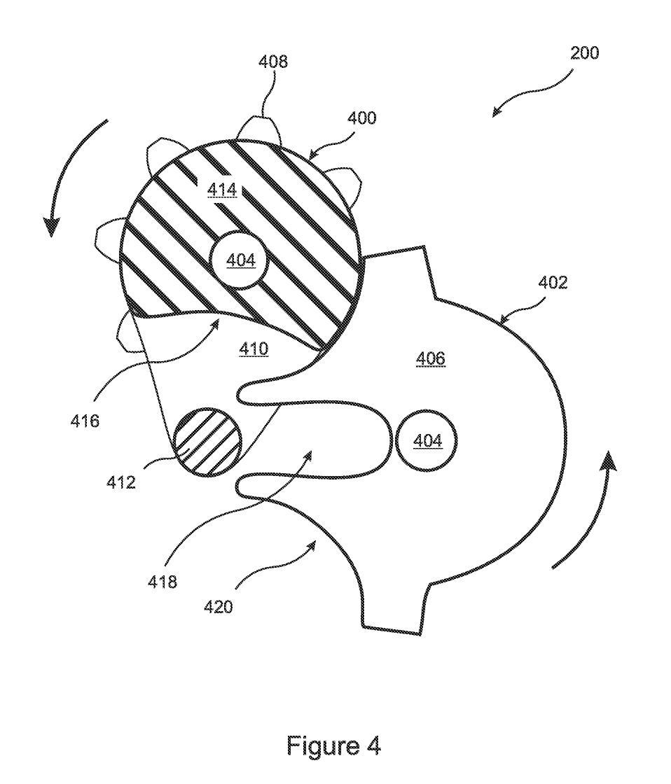

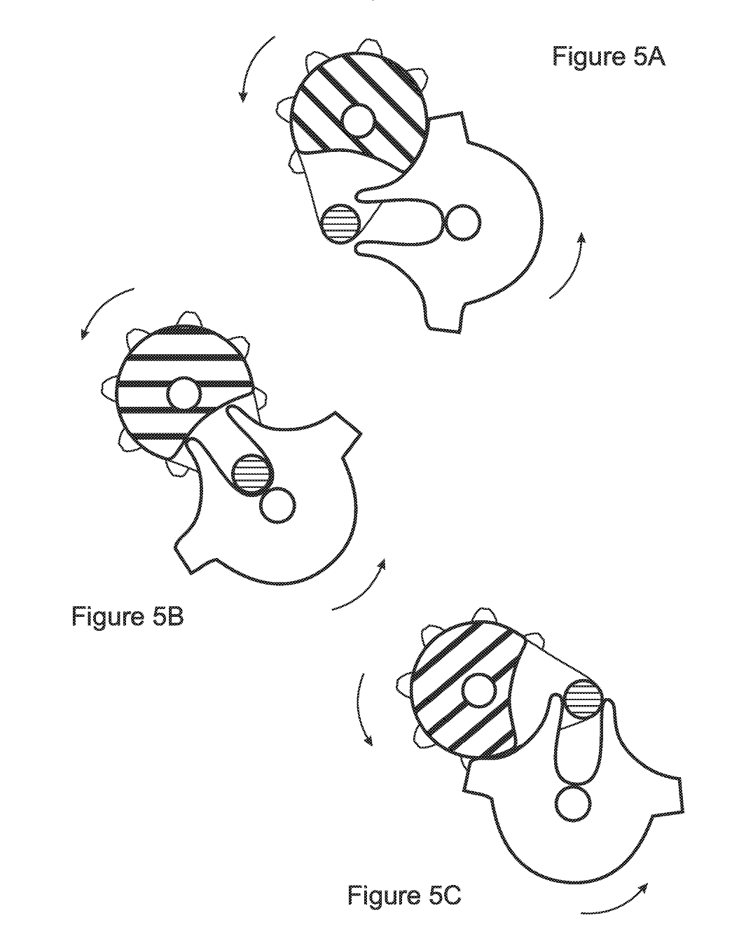

FIGS. 5A through 45 illustrate the operation of the Geneva drive of FIG. 4. FIG. 5A is a reproduction of FIG. 4, with the item numbering removed for better visual clarity. In FIG. 5A, the Geneva drive is in a starting orientation, as described above. FIG. 5B shows the Geneva drive of FIG. 5A in an intermediate orientation, where the driving section has rotated 400, and the drive pin 412 has entered the notch 418 in the shutter section plane 406. In this drawing, the need for the inwardly curved portion 416 of the upper layer 414 of the drive section 400 can be seen, since it allows the ends on either side of the notch 418 of the shutter section plane 406 to pass by the upper layer 414.

FIG. 5C illustrates the embodiment of FIG. 5A in the end orientation. This orientation is substantially a mirror-image of the starting orientation of FIG. 5A, where the plane 406 of the shutter section 402 is once again locked in position due to close conformity of the inwardly curved portion 420 with the round portion of the upper layer 414 of the drive section 400.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

What is claimed is:

1. An apparatus for transitioning a switchable element between a first switched position and a second switched position, the apparatus comprising:
an actuating mechanism that can be transitioned between a first configuration and a second configuration; and
a Geneva drive comprising a drive section coupled to the actuating mechanism and a shutter section coupled to the switchable element,
the drive section being rotated between a first orientation and a second orientation when the actuating mechanism is transitioned between the first configuration and the second configuration,
the shutter section being rotated by the drive section between a first position and a second position when the drive section rotates between the first orientation and the second orientation, the switchable element being thereby transitioned respectively between the first switched position and the second switched position,
the shutter section being unable to apply a torque to the drive section when the drive section is in either of the first orientation and the second orientation.

2. The apparatus of claim 1 wherein, the switchable element is a camera shutter.

3. The apparatus of claim 1, wherein the actuating mechanism includes a rotary actuator.

4. The apparatus of claim 1, wherein the actuating mechanism includes a linear actuator.

5. The apparatus of claim 4, wherein the actuating mechanism includes a pivot gear.

6. The apparatus of claim 1, wherein the actuating mechanism includes a piezomotor.

7. The apparatus of claim 1, further comprising sensors that detect when the actuating mechanism is in one of the first configuration and the second configuration.

8. The apparatus of claim 1, wherein at least one of the first and second switched positions can be adjusted by correspondingly adjusting at least one of the first configuration of the actuating mechanism and the second configuration of the actuating mechanism.

9. The apparatus of claim 8, wherein the actuating mechanism can be mechanically adjusted.

10. The apparatus of claim 8, wherein the actuating mechanism includes a sensor that can sense a range of configurations of the actuating mechanism, and at least one of the first and second configurations of the actuating mechanism can be electronically adjusted by adjusting a setting of a controller that receives input from the sensor.
